(19) United States
(12) Patent Application Publication
(10) Pub. No.: US 2025/0058216 A1
(43) Pub. Date: Feb. 20, 2025

(54) PROGRAM, MATCH-MAKING SERVER, AND MATCH-MAKING SYSTEM

(71) Applicant: BANDAI CO., LTD., Tokyo (JP)

(72) Inventors: Yusaku KUBOTA, Tokyo (JP); Tatsuya MORIMOTO, Tokyo (JP); Yushiro UEHARA, Tokyo (JP); Issei HOSODA, Tokyo (JP)

(21) Appl. No.: 18/806,763

(22) Filed: Aug. 16, 2024

(30) Foreign Application Priority Data
Aug. 18, 2023 (JP) 2023-133643

(51) Int. Cl. A63F 13/48; A63F 13/87; G06T 13/40

(52) U.S. Cl. CPC A63F 13/48; A63F 13/87; G06T 13/40

(57) ABSTRACT

A match-making system comprises a display unit displaying first and second virtual spaces where virtual characters associated with users are movably placed, a match-making unit performing match-making of users for a game, a trigger unit triggering the game where the users involved in the match-making participate if the match-making is established, and a communication unit controlling transmission and reception of information related to users' communication, wherein the match-making unit performs the match-making on users whose virtual characters associated therewith are placed in the first virtual space, the communication control unit performs a control to enable the communication related to a match-making reservation between the users whose virtual characters associated therewith are placed in a same second virtual space, and a control unit controlling the match-making unit to establish the match-making about the users who make communication related to the match-making reservation in the second virtual room.

### CROSS-REFERENCE TO RELATED APPLICATIONS

The disclosure of Japanese Patent Application No. 2023-133643 filed on Aug. 18, 2023 including specification, drawings and claims is incorporated herein by reference in its entirety.

### TECHNICAL FIELD

The present invention relates to a program, a match-making server, and a match-making system, and specifically relates to a match-making service using a virtual space.

### BACKGROUND

There is a game system where users can compete in a competitive game or battle game against an opponent(s) selected by the user from a list of candidate users determined by a server (for example, Japanese Patent Application Publication No. 2015-037462).

### SUMMARY

### Technical Problem

In the case where the candidate users are determined by the server as described in Japanese Patent Application Publication No. 2015-037462, there is a low probability that the user can play a competitive game with a person with who the user desires to be matched, such as an acquaintance or someone with whom the user has played.

It is an object of the present invention to provide a program, a match-making server, and a match-making system which offers a math-making service with enhanced interest.

### Solution to Problem

One of the aspects of the present invention is a program. The program causes a computer to perform a display control process which displays a virtual space where a virtual character associated with a user is placed so as to be movable; a match-making process which match-makes two or more users who play with each other in a game, a trigger process which triggers execution of the game in which two or more users involved in the match-making process participate, on condition that a match-making is established in the match-making process, and a communication control process which controls transmission and reception of information related to communication between the users, wherein the virtual space includes a first virtual space and a second virtual space, the match-making process, is performed for users whose virtual characters are placed in the first virtual space, and in the communication control process, communication about match-making reservation between the users whose virtual characters are placed in the second virtual space is enabled, and in the match-making process, match-making of two or more users who have made communication about the match-making reservation is established.

### Advantageous Effect of Invention

It is an object of the present invention to provide match-making service with improved enjoyability.

### BRIEF DESCRIPTION OF DRAWINGS

FIG. 1 illustrates the configuration of a match-making system according to an embodiment of the present invention and modifications thereof;

FIG. 2 illustrates a hardware configuration of a user terminal 100 according to the embodiment of the present invention and modifications thereof;

FIG. 3 illustrates the hardware configuration of a server 200 according to the embodiment of the present invention and modifications thereof;

FIG. 4 illustrates an avatar used in the match-making service according to the embodiment of the present invention and modifications thereof;

FIG. 5 illustrates a battle room of the match-making service according to the embodiment of the present invention and modifications thereof;

FIGS. 6A and 6B are diagrams explaining a match-making function in the battle room according to the embodiment and modifications of the present invention;

FIGS. 7A and 7B illustrate a play screen of a battle game according to the embodiment of the present invention and modification thereof;

FIGS. 8A-8E show an example of various types of information managed in the match-making service according to the embodiment of the present invention and modifications thereof;

FIG. 9 illustrates an example of an entrance room of the match-making service according to the embodiment of the present invention and modifications thereof;

FIG. 10 illustrates display of avatars in a friend relationship in the entrance room according to the embodiment of the present invention and modifications thereof;

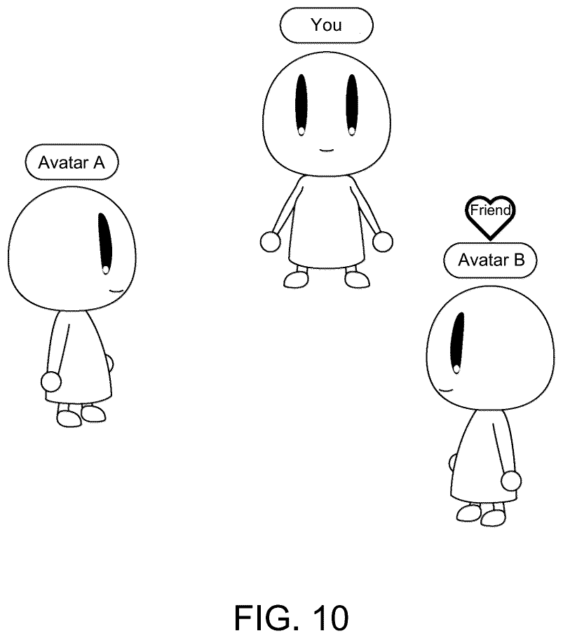

FIG. 11 is a flowchart illustrating a reservation process executed by the server 200 according to the embodiments of the present invention and modifications; and

FIG. 12 is a flowchart illustrating a display control process executed by a user terminal according to the embodiments of the present invention and modifications thereof.

### DETAILED DESCRIPTION

### Embodiment 1

Embodiments will be described in detail below with reference to the accompanying drawings. It should be noted that the embodiments described below are not intended to limit the invention set forth in the appended claims. In addition, not all the combinations of features described in the embodiments are essential to the invention. Two or more features of a plurality of the features described in the embodiments may be combined as desired. Further, the same reference numbers are respectively given to the same elements or similar elements and duplicate description therefor will be omitted.

The embodiment is described below as one example of a match-making system, wherein the present invention is applied to a system, in which a server accepts connection from an information processing apparatus (a user terminal) used by a user, provides a service for realizing a match-making for a two player game (such as a one-to-one match game, a versus game, battle game, competition game, one-to-one match, fighting game and the like) provided in an outside service via a virtual space. However, the present invention can also be applied to a system realized by any device configuration which can perform match-making for a game involving three or more users via such a virtual space, and which can trigger execution of the game.

In this specification, the term ‘user’ refers to one who utilizes the service (match-making service) provided by a server 200 within a match-making system. For convenience, a user, for whom the match-making has been established in the virtual space and who is playing the game, may be referred to as a ‘player’.

### <<Configuration of the Match-Making System>>

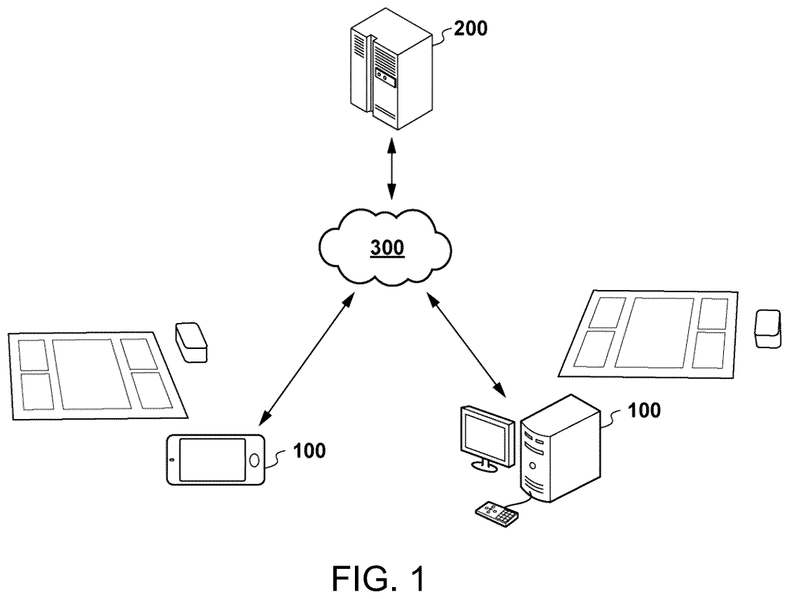

FIG. 1 illustrates the configuration of a match-making system according to the present embodiment. As shown in the figure, the match-making system is configured such that the server 200 can communicate with multiple user terminals 100 through a network 300. The server 200 according to the embodiment, provides the match-making service, in which the match-making system performs match-making for the users of connected user terminals 100 as players of a battle game, which is realized by the outside service, thereby triggering the execution of a battle game.

In the explanation set forth below, the outside service is described as a service for supporting execution of a play of the battle game between or among remote players. The service does not have a free match-making type function for picking up the required number of players for the service provision. In the outside service according to the embodiments, when the required number of players access a room (connection destination) created by a host player using their user terminals 100, a video chat function utilizing a camera and a microphone of each of the user terminals 100 becomes available, thereby realizing the game play of a trading card game (TCG) progressing while sharing the status of game items therefor, which are developed in the real-world environment where the players exist. Therefore, each of the user terminals 100 can be a personal computer or a smartphone equipped with a camera and a microphone.

Details will be described later, but users of the match-making service can use the service by logging in using the user terminal 100. In the service, a virtual space where the avatar (operable avatar) associated with the user is arranged can be displayed. The match-making service is a web service accessible via a browsing application (hereinafter simply referred to as ‘browser’), and in the service, a login is performed by completing the user authentication process on a specific web page. The users can move the operable avatar placed in the virtual space by performing various operation inputs, communicate with other users through the avatar (by text chat etc.), and can be matched with an opponent for a battle game provided by the outside service.

### <Hardware Configuration of User Terminal>

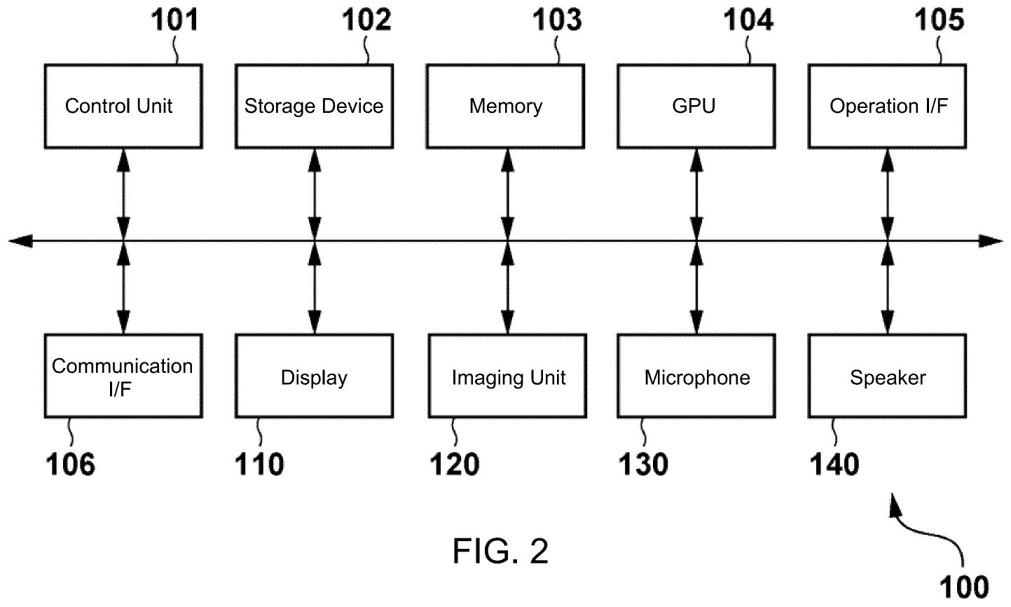

Next, the hardware configuration of the user terminal 100 will be described with reference to FIG. 2. FIG. 2 is a block diagram illustrating the hardware configuration of the user terminal 100.

The control unit 101, which is a processor such as a CPU, performs various controls including operation control of the hardware provided in the user terminal 100. Specifically, the control unit 101 reads the necessary programs stored in a storage device 102, deploys them in a memory 103, and executes them to perform the corresponding control.

The storage device 102 is a device capable of permanently storing information, such as a non-volatile memory or HDD. The storage device 102 stores programs the operating system requires for the operation of user terminal 100 and various application-related programs, in addition to information on parameters necessary for realizing various controls, and various data used for display and communication functions related to the browser. The memory 103 is a storage device used for a temporary data storage, such as a volatile memory. The memory 103 may be used not only as a deployment area for each program but also as a storage area for temporarily storing data output during operations of various hardware and processes of various controls.

The GPU 104 is an image drawing device which performs various drawing processes related to generation of display screens for the user terminal 100. The GPU 104 also performs drawing processes for screens related to the virtual space, which is presented in the browser during the use of the match-making service. The GPU 104 includes a GPU memory (not shown) and deploys various graphics data read from the storage device 102, performs predetermined calculations to generate various images including the screens. The screens and images generated by the GPU 104 are displayed on a display 110 provided in the user terminal 100, so as to be presented to the user. The display 110 which displays information may be a liquid crystal display or the like, and is provided in the user terminal 100 or may be a device detachable from the user terminal 100. The display 110 displays the screens generated by the GPU 104.

An operation interface 105 is provided in the user terminal 100, and is a user interface for receiving operation inputs. When the operation interface 105 detects that an operation input has been made, it outputs a control signal corresponding to the operation input to the control unit 101. In one embodiment, the operation interface 105 may include operation components such as buttons provided on the exterior of the user terminal 100 and various sensors. Additionally, the display 110 provided in the user terminal 100 is configured to detect a touch input, and the operation interface 105 includes a touch input detection sensor provided on the display 110.

The communication interface 106 is provided in the user terminal 100 and is an interface for communicating with external devices. The information communication between the communication interface 106 and the external devices can be carried out via a wide-area network (WAN) such as the internet or through a local area network (LAN). Although the information communication handled by the communication interface 106 is wirelessly performed, it is not limited thereto, and may be performed by wired communication.

An imaging unit 120 includes an imaging device having an imaging element such as a CCD or CMOS sensor. As detailed later, during the execution of a battle game related to the outside service, the imaging unit 120 intermittently captures images of game cards placed in the imaging range by the user and outputs these captured images.

The microphone 130 is an audio input interface provided in the user terminal 100. In this embodiment, since the battle game related to the outside service triggered by the match-making service is a card trading game (TCG), the microphone 130 acquires sounds related to declarations of players and the reading aloud of the effects of a game card. Additionally, the speaker 140 is an audio output interface provided in the user terminal 100. The speaker 140 outputs sounds related to the match-making service and audio related to the battle game (such as declarations by the opposing player or sound effects).

### <Server Hardware Configuration>

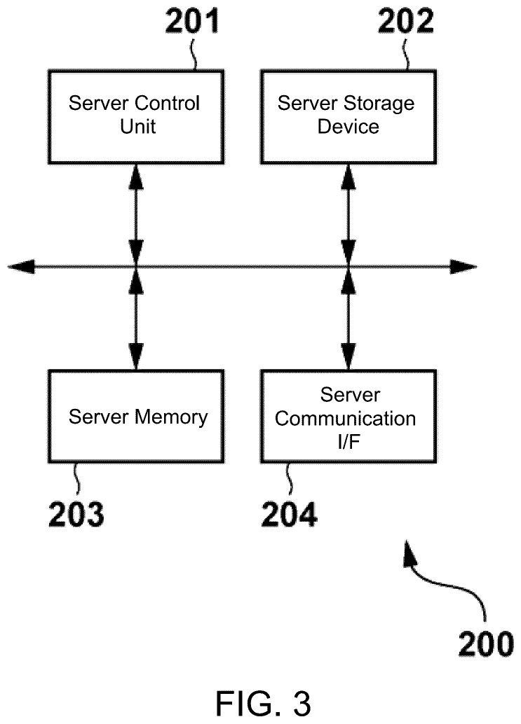

FIG. 3 shows a block diagram of a hardware configuration of the server 200 according to the present embodiment. In the following description, in order to distinguish a hardware structure of the server 200, which achieves the same functions as that of the user terminal 100, from that of the user terminal 100, the prefix “server” is added to the components related to the server.

The server control unit 201 is a processor, such as a CPU, which performs control related to realization of various functions including an operation control of each hardware provided in the server 200, a user management related to a match-making service, and a match-making function for users. Specifically, the server control unit 201 reads necessary programs stored in the server storage device 202, deploys them in the server memory 203, and executes them to perform the corresponding control.

The server storage device 202 is a device capable of permanently storing information, such as non-volatile memory, an HDD and the like. The server storage device 202 stores programs related to the operating system necessary to operate the server 200, programs related to match-making, in addition to information of parameters required to realize various controls, and various data required for the match-making function. Additionally, the server storage device 202 includes a database function to manage the information of each player registered as a user of the match-making system. The server memory 203 is a storage device used for temporarily storing data, such as volatile memory. The server memory 202 is used not only as a deployment area for each program but also as a temporary storage area for data output during the operation of the various hardware and various control processes.

The server communication interface 204 is an interface for communicating with external devices, and is provided in the server 200. Information communication between the server communication interface 204 and the external devices can be conducted via a wide-area network (WAN) such as the internet etc. or through a local area network (LAN). The information communication handled by the server communication interface 204 can be conducted either wirelessly or through wired connections.

### <Overview of the Match-Making Service>

Below, the overview of the match-making service provided by the match-making system in this embodiment will be described with reference to the drawings.

As described above, the match-making service becomes available when a user, using the user terminal 100, launches a browser to access the web page (service site) related to the service and logs into the service.

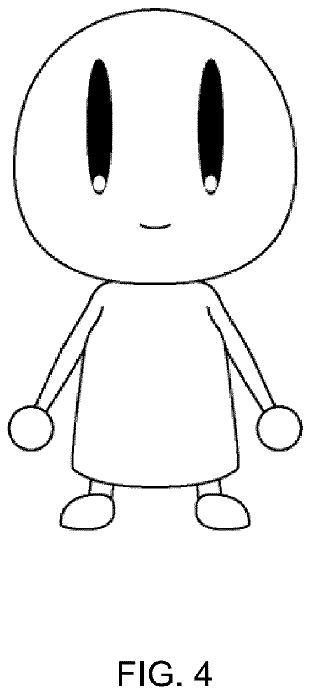

After the service login, a virtual space represented in 3D computer graphics, is displayed as a service screen on each user terminal 100. The service screen is a drawn image of the virtual space, and the number of pixels is set according to the area where the web page of the browser is displayed. In the virtual space, a humanoid 3D model (virtual character) such as an avatar having a head, torso, arms and legs as shown in FIG. 4 (hereinafter referred to as an operable avatar) is assigned to each user. Each user can move the operable avatar assigned to him or her, within the virtual space by performing an operation input(s) related to the movement. In this embodiment, the virtual space is configured as a room-like 3D space, and hereafter, the virtual space may be referred to as “a room” sometimes. Accordingly, the operable avatar moves within the room based on a user's operation input. The room is configured as a space with a certain level of expanse.

In the match-making service according to the embodiment of the present invention, two or more types of virtual spaces are provided, and each user can navigate between these virtual spaces depending on the intended use of the service. That is, the operable avatars of the users are managed by the server 200 such that each of them is placed in only one virtual space at a time.

The virtual space used in the match-making service includes two types: an entrance room and a battle room. The two types of virtual spaces (rooms) have different purposes, and the process(es), which can be executed as a function(s) of the match-making service based on a request(s) from the user, depends on which virtual space the operable avatar is placed. In other words, the functions of the match-making service available to the user change according to whether the operable avatar is placed in the entrance room or the battle room. When the user login the service, the operable avatar is controlled to be placed in only one room, and it is not placed in multiple rooms simultaneously. Movement (transfer or transition) between rooms is basically achieved when an operation input related to the movement is made in each room, and the corresponding request is sent from the user terminal 100 to the server 200, where the information managed about the operable avatar is updated.

Among the two (or more) types of rooms, the battle room is the virtual space where a function of the match-making (match-making function) is actually provided so as to match-make a user with an opponent for the battle game the user wants to play. When the match-making is established in the battle room, the execution of the battle game is triggered. On the other hand, the entrance room fundamentally does not provide with the function for match-making a user with an opponent, but provides a user with an auxiliary function(s) (hereinafter referred to as an auxiliary function) such as configuring an operable avatar and selecting a battle room for moving the operable avatar. Thus, in the entrance room, the match-making cannot be established, and the execution of the battle game is not triggered. The features of each of the rooms will be explained in more detail below. In the following explanation, the state where the operable avatar assigned to a user is placed in the 3D space related to either of the rooms may be referred to as the user of the operable avatar “entering the room”.

### <Entrance Room>

As described above, the entrance room is a virtual room where the auxiliary function(s) is provided to allow each user to utilize the battle room. In addition, the entrance room is provided for each operable avatar, and, for example, the entrance room is associated with an avatar ID which uniquely identifies the operable avatar. In other words, the entrance room is a virtual room, which is uniquely provided for each operable avatar.

When a user logs into the service site, the operable avatar of the user is first placed in the entrance room provided for that operable avatar, and is displayed. The user can perform an operational input for use of the various auxiliary functions by, for example, moving the operable avatar within the entrance room.

### (Appearance Customization Function)

An appearance customization function is included as an auxiliary function available in the entrance room, by which the appearance of the operable avatar can be changed. The user can change drawing elements which form the appearance of the avatar, that is, the color of the avatar or items attached to the head, body, etc. can be changed differently. Within the entrance room, the user can change the appearance of the operable avatar by selecting items to be attached, from a list of items the user owns.

### (Transfer Function)

The auxiliary functions also include a transfer function for selecting a battle room according to the user's transfer request and for transferring the operable avatar of the user to the selected battle room.

As will be described in detail later, in the match-making service according to the present embodiment, the operable avatars respectively associated with users who desire match-making with opponents are placed in the battle room at that same period, and such a state is displayed on the display 110 of the user terminal 100 of each user as a service screen (a screen related to the match-making service presented to the user through a browser). To generate the service screen showing the state of the match-making room, information indicating the state of other avatars placed in the match-making room (for example, whether they are in the process of matching-making, and/or what their appearance is, etc.) is required. This information is associated with the battle room in the server 200 and managed therein, and when the user's operable avatar is placed in the battle room, the information is shared by the user terminals 100 and used to generate the service screen.

Therefore, the more avatars placed in the battle room, the greater the amount of information to be referenced when generating the service screen, which may increase the computational load in the user terminal 100. Hence, in the match-making system according to the present embodiment, an upper limit regarding the number of operable avatars that can be placed in the room (the maximum number of users who can enter) is set for each battle room. On the other hand, multiple battle rooms are prepared so that the number of users who can use the match-making function at the same period is secured. The transfer function is performed by the server control unit 201 so that a battle room is selected based on the user's request from among these multiple battle rooms provided in parallel, and the operable avatar associated therewith is transferred.

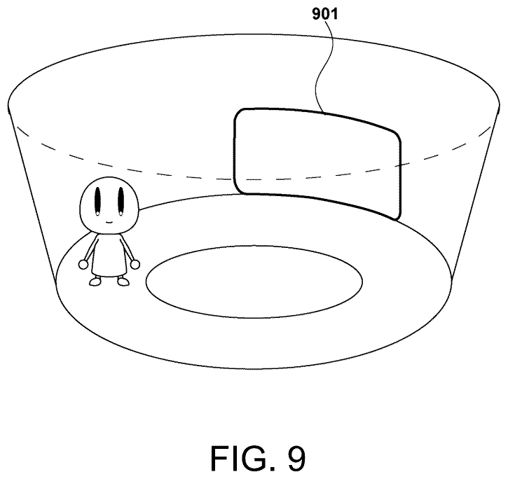

In the match-making system according to the present embodiment, an entrance room is provided as a space enclosed by wall portions and a window portion, as shown in FIG. 9. If a user can move the operable avatar to a predetermined position within this space, the user can perform an operation input related to the use of a function for transferring the operable avatar to the battle room. The following describes an example where the user interface related to the transfer to the battle room is presented to the user by moving the operable avatar near a window portion 901 within the entrance room.

By performing the operation input related to the transfer to the battle room, the user can send a request for transferring the operable avatar to the battle room, to a server 200. In response to this transfer request, the server 200 determines to which battle room the operable avatar of the user will be transferred (placed). The server control unit 201 then performs the process to transfer the operable avatar to the determined battle room.

### (Visit Function)

Further, the auxiliary functions also include a visit function which allows the user to visit an entrance room provided for an avatar of another user. For example, the user can use the visit function by selecting, from a menu which can be displayed when the operable avatar is in an entrance room, an instruction item related to the movement of the operable avatar to another entrance room. With the visit function, the operable avatar associated with the user is moved to and displayed in the entrance room provided for the avatar of another user. The entrance room to which the operable avatar is positioned by the visit function may be, for example, determined by the server control unit 201 or determined based on the user's selection of the avatar to visit.

The match-making service provides a friend registration function for operable avatars. On the condition that, for example, a user and an acquaintance or a user with whom the user has played against before have agreed to have a friend relationship, this function sets a friend relationship to avatars associated with these users. Accordingly, for example, the users having a friend relationship between avatars can check their login status or easily visit their entrance rooms. For example, when the user's operable avatar is positioned in its entrance room and an avatar having a friend relationship with the user visits the entrance room, an icon indicating that the avatar is a friend is displayed in the vicinity of the avatar, as illustrated in FIG. 9. Thus, the user can recognize that the user's friend is visiting. A relationship between avatars that is explicitly displayed is not limited to the friend relationship, but can also include, for example, a relationship that the avatars have played against each other in a battle game in the past.

In this way, with the visit function, a user can let other users see the entrance room associated with the user's own operable avatar. Therefore, in the match-making service according to the present embodiment, each entrance room is configured to allow a corresponding user to change the interior and decoration of the room to produce the uniqueness of the user. Each user can decorate the interior of the entrance room by, for example, placing any decorative object obtained by the user.

Further, the interior decoration in the entrance room may include a decorative element which changes in accordance with the state of the operational avatar associated with the entrance room. Such a decorative element may include, for example, an element which changes in accordance with at least one of the number of times a user has played and the number of times the user has won the battle game executed after the user is matched with another user via the operable avatar. Further, in a case where a competition, a play season, or the like is available for the battle game, the decorative element may also include an element such as a trophy or a medal which relates to the play result of the battle game executed after match-making is performed via the operable avatar.

### (Battle Room)

The battle room is a virtual space in which all of the users can be matched with each other for the battle game in the match-making service. Unlike the entrance room, not only the operable avatar but also the avatars of other users who have entered the same room are placed in the battle room. The users who have entered the battle room can move their operable avatars within the battle room by performing an operation input related to the movement. Therefore, in the battle room, each user whose avatar is placed in the battle room can move the avatar associated with that user and use a function specific to the battle room.

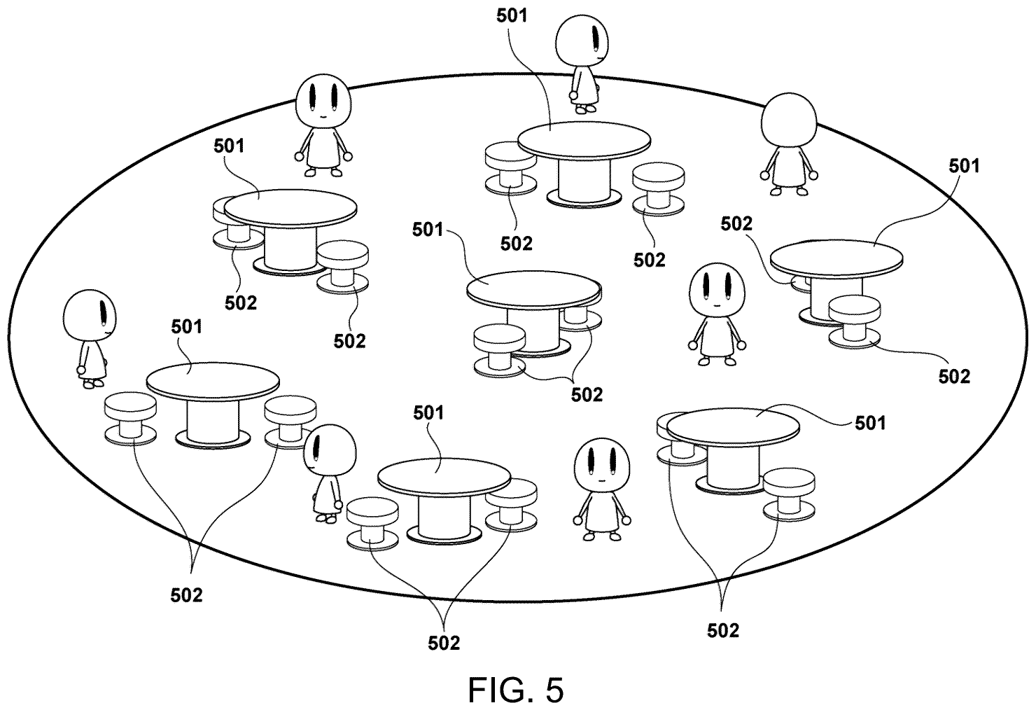

As illustrated in FIG. 5, a plurality of table objects 501 are arranged in the battle room. Further, chair objects 502 are disposed in the vicinity of each table object 501. A user who wants to be matched with another user can use the match-making function by selecting any of the table objects 501. When a match-making request related to the use of the match-making function is made, the server control unit 201 performs a process related to the match-making. Further, when the match-making is established through the process related to the match-making, the match-making service triggers the execution of the battle game related to the outside service in which (two) users who have been matched with each other participate.

### (Match-Making Function)

The match-making function matchmakes a user with an opponent for the battle game related to the outside service. In the match-making service according to the present embodiment, a match-making request is accepted in response to an operation of selecting a table object in the battle room. Therefore, an opponent matched with the user is a user whose avatar is placed in the same battle room.

The server 200 does not forcibly perform match-making to match the user with an opponent, but performs match-making after agreement is reached between the users. Specifically, assume that there is a user who wants another user to request a battle against the user. In this case, the match-making function allows another user who wants a battle against the user, to request a battle to the user. When the user accepts the battle request from the other user, the match-making function establishes the match-making to match the user with the other user. The process related to the match-making starts in response to an operation of selecting one table object, and the state of the process is presented to the user through the display with the table object.

When a user who wants to wait for a battle request from another user performs an operation of selecting a table object, a confirmation is displayed to confirm that the state of the operable avatar transitions to a match-making standby state. After that, a match-making request for standby (hereinafter occasionally referred to as “standby request”) is transmitted to the server 200. The standby request may include, for example, identification information which uniquely identifies the table object (a combination of a room ID, which uniquely identifies the battle room, and a table ID, which uniquely identifies the selected table object in the battle room) and identification information which uniquely identifies the user (or the user's operable avatar) who has made the standby request. When the server control unit 201 receives the standby request, the server control unit 201 updates the state of the operable avatar of the user to the match-making standby state and transmits the information to the user terminals 100 of the users who have entered the same battle room.

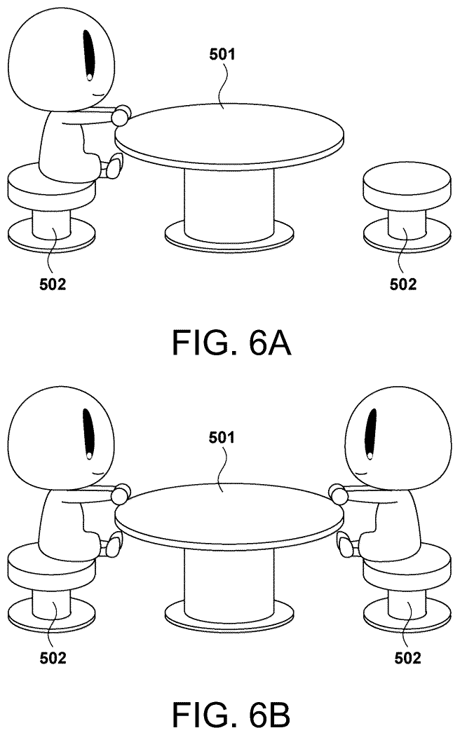

In the match-making standby state, the user's operable avatar is displayed such that the operable avatar is seated on one of the chair objects 502 disposed in the vicinity of the table object 501 on which the selection operation has been performed, as illustrated in FIG. 6A. Since a TCG is generally played on a one-to-one basis, two chair objects are disposed in the vicinity of each table object so as to face each other across the table object in the match-making system according to the present embodiment. The display of the avatar in such a seated state continues until the user performs an operation input related to the cancellation of the standby or until the battle game executed after the establishment of match-making is completed. In other words, the user's operable avatar in the match-making standby state is displayed without moving from the position of the chair object 502 in the vicinity of the table object 501 in the battle room. In the match-making standby state, even when the user performs an operation input related to the movement of the operable avatar, the operable avatar is controlled so as not to move.

With one user's avatar seated in the chair object 502 and being in the match-making standby state (such a table object 501 will be hereinafter referred to as “standby table”), other users can make a battle request to the table object 501. In other words, the table object 501 is in a state in which a match-making process related to the match-making standby state is being performed. In response to the match-making process related to the match-making standby state being performed, the table object 501 is displayed in a different mode from a previous one (when the process is not performed). For example, the color of the table object 501 is changed. Accordingly, other users can recognize that they can make a battle request to the table object 501.

A user who wants to make a battle request can perform an operation input to the standby table to make a battle request to a user (hereinafter referred to as “standby user”) of an avatar which has arrived the standby table earlier (hereinafter referred to as “standby avatar”). Specifically, for example, when an operation input to the standby table is performed on the user terminal 100 used by the user who makes the battle request (hereinafter referred to as “requesting user”), the confirmation of making a battle request is displayed and then a match-making request for making the battle request is transmitted to the server 200. The match-making request may include, for example, identification information which uniquely identifies the standby table and identification information which uniquely identifies the requesting user (or the requesting user's operable avatar). When the server control unit 201 receives the match-making request, the server control unit 201 temporarily updates the state of the requesting user's operable avatar (hereafter referred to as “requesting avatar”) to the match-making standby state and shares this information with the user terminals 100 of the users who have entered the same battle room.

When the requesting avatar becomes the match-making standby state, the requesting avatar is displayed such that the requesting avatar is seated in the chair object 502 in the vicinity of the standby table as with the standby avatar, and the requesting avatar and the standby avatar face each other across the table object 501, as illustrated in FIG. 6B. This display continues until the requesting user performs an operation input related to the cancellation of the battle request, until the standby user performs an operation input related to the rejection of the battle request, or until the battle game executed after the establishment of match-making is completed. In other words, the requesting avatar in the match-making standby state is displayed without moving from the position of the chair object 502 in the vicinity of the standby table in the battle room. In the match-making standby state, even when the requesting user performs an operation input related to the movement of the requesting avatar, the requesting avatar is controlled so as not to move.

When the standby avatar and the requesting avatar are seated so as to face each other across the table object 501 in this manner, the server 200 transmits, to the user terminal 100 of the standby user, an inquiry as to whether or not to accept the battle request from the requesting user. The standby user can perform an operation input to accept or reject the battle request made by the requesting user. When the standby user accepts the battle request, the server control unit 201 performs a process of matching the standby user with the requesting user to establish match-making. The server control unit 201 then updates the status information managed for both avatars during the match-making. In other words, the standby user and the requesting user who have been matched become players of the battle game to be subsequently triggered.

In this way, with a table object disposed in a battle room, match-making can be established between users who have entered the same room. That is, in each battle room, the maximum number of match-making that can be performed at the same time period corresponds to the number of table objects arranged in the battle room. Therefore, the server 200 manages information regarding the state of each table object in each battle room. Examples of the state information include whether the match-making process is being performed, whether the execution of the battle game is triggered after the establishment of match-making, and neither of them is performed (neither the match-making process is being performed nor the execution of the battle game is triggered).

When the battle game is triggered after the establishment of match-making, the corresponding table object 501 may be displayed in a further different mode until the triggered battle game is completed. Changing the display mode of the table object 501 in this way allows other users to recognize that match-making has already been established.

In this way, in the match-making service according to the present embodiment, since a series of processes related to match-making is performed via the table object 501, avatars are controlled so as not to enter the area where the table object 501 is disposed in the battle room. On the other hand, a standby avatar and a requesting avatar are controlled during the series of processes such that they can be placed in the area where the chair objects 502 are disposed. Therefore, the avatars are controlled such that they can enter the area where the chair objects 502 are disposed. In this case, only the avatars that are actually involved in the match-making process and positioned in the area of the chair objects 502 are controlled to be seated.

### (Battle Function)

[A battle function is a function which executes a battle game in which users who have been matched with each other in a battle room participate. As described above, in the match-making system according to the present embodiment, the battle game is realized using the outside service.

After match-making is established in the battle room, the server 200 transmits a request to a game server of the outside service, which is not illustrated, to create a connection destination of a battle game, together with information regarding the two players (a standby user and a requesting user) who have been matched. The game server creates a new connection destination of the new battle game in response to the creation request and transmits connection destination information to the server 200. The server 200 then transmits, together with a transfer instruction, the received connection destination information to the user terminal 100 used by each player. At the user terminal 100 which has received the transfer instruction, a connection to the connection destination is triggered on the browser and the display is switched from the match-making service to the outside service. This configuration eliminates the need for each player to directly perform a registration procedure for the outside service and allows each player to start the battle game against the player's opponent who has been matched with the player in the match-making service.

In the present embodiment, the login state in the match-making service is maintained even while the display of the user terminal 100 has transitioned to the outside service (during the execution of the battle game in the outside service) so that each player can easily return to the match-making service after finishing the battle game. In more detail, for example, when the user terminal 100 of each player receives information regarding the connection destination of the outside service, the user terminal 100 opens a different tab (or a different window) of the browser and establishes a connection to the connection destination. Accordingly, the tab for the outside service is displayed as a main tab. That is, the tab for the outside service is selected as a display tab and the display of the browser is switched (the tab for the outside service is displayed instead of a tab displaying the service screen of the match-making service, or a different window is displayed at the front). This triggers temporal transition from the match-making service to the outside service. At this time, the tab for the match-making service is still present even while the outside service is in use. Therefore, each player can check both the state of the battle room in the match-making service and the play screen of the battle game in the outside service.

As described above, the battle game related to the outside service for which the match-making system according to the present embodiment matches players is a TCG. Simply put, a TCG proceeds as follows. Each player builds a deck using game cards which are real items and obtains a game card that serves as an initial hand from a shuffled deck. Each player adds, on their turn, a game card from the deck to his or her hand and, when necessary, arranges the cards in his or her hand on a play field. A player declares the action of a card placed on the play field and performs various operations related to the resolution of the declaration. Therefore, it is essential to be able to check the state of the playing field of each player in the progress of the battle game. For this reason, the battle game executed using the outside service proceeds using a video chat function to share, among the players, videos capturing the players' hands and the voices of the declaration made by the players.

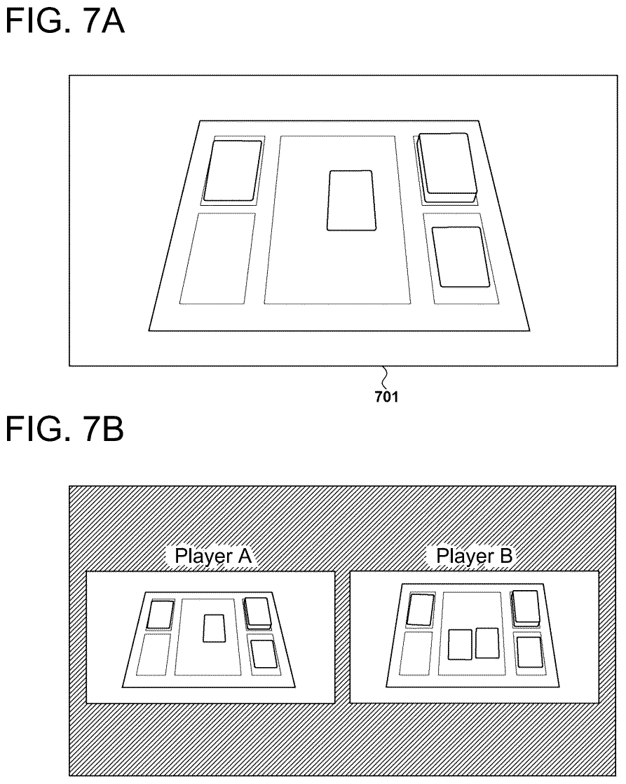

The screen (play screen) displayed on the user terminal 100 used by a player during the game play may, for example, display a live video 701 itself captured by the user terminal 100 used by an opponent of the player, as illustrated in FIG. 7A. In the example of FIG. 7A, the video 701 captured by the user terminal 100 used by the opponent is displayed as it is in full screen. Alternatively, the play screen may display a frame image of the video 701 with a predetermined GUI.

When the battle game related to the outside service ends, the display of the user terminal 100 used by each player returns from the outside service to the match-making service. The information (end information) indicating that the players have finished using the outside service may be transmitted from the user terminal 100 of at least one of the players to the server 200 or may be transmitted directly from the game server of the outside service to the server 200. The end information also includes information regarding the result (win or loss) of the battle game. To display the result of the battle game played by each player based on the received end information, the server 200 performs control so as to transmit, together with a display request, information for displaying the result of the battle game to the user terminals 100 used by the players. When the user terminal 100 of each player receives the information, the user terminal 100 displays the result of the battle game executed using the outside service.

Further, when the server control unit 201 receives result information regarding the battle game played by the players, the server control unit 201 updates information regarding the battle result managed for the corresponding users and also updates the state of the avatars of the users from a matched state to a non-matched state (free state). The avatar of each user whose state has been changed to the free state is no longer seated in the chair objects in the vicinity of the table object and is displayed as an away state. Then, the avatar can move between the battle rooms again according to an operation input performed by the user terminal 100 used by the user as with the state becoming the match-making standby state.

(Spectator Function) A spectator function allows users other than players to watch a battle game whose execution has been triggered via a battle room. In other words, the match-making service according to the present embodiment provides a function relating to watching of the battle game executed via the battle room as an element of entertainment that can be enjoyed by users who have entered the battle room but are not matched. The spectator function may be realized by using, for example, a publication function provided by the outside service related to the battle game. The publication function publishes the play screen transmitted and received between the user terminals 100 used by the players who are playing the battle game.

For example, a user can make a spectator request to watch a battle game executed via a table object by performing, on the service screen of the match-making service, an operation input to the table object through which the battle game is being executed. In response to the user making the spectator request to the table object where match-making has been established, the user terminal 100 used by the user making the spectator request switches the display to display the play video of the battle game related to the table object. In this case, the user's operable avatar may be controlled so as to be displayed to other users such that the user's operable avatar is watching the table object in the vicinity of the table object, for example.

With the spectator function, the display 110 of the user terminal 100 of the user who has made the spectator request may display, for example, a video focusing on cards at one player's hand as illustrated in FIG. 7A or an image including videos of cards at both players' hands during the battle game as illustrated in FIG. 7B.

### <Reservation Function>

In the usual match-making process in the battle room, there are cases where a user may not be reliably match-made with a desired opponent. Specifically, when the operable avatar of the user becomes seated at a table object first, another user who selects the table object based on a first-come-first-served basis, can request a competition (battle). This means that depending on the timing, it might take time until the request for competition from the desired user are made. Similarly, when the operable avatar of the user is seated later at the table object (a request for competition), if the earlier seated user does not accept the request for competition, the request for competition made by the user seated later at the table cannot plat with the earlier seated user. As a result, the duration required for each user to engage in match-making might lengthen over a long period.

Therefore, in the match-making service according to the present embodiment, a function (reservation function) is provided to allow a user to reserve match-making with another user if the user visits the entrance room associated with that user (another user) using the operable avatar. The match-making reservation using the reservation function is made under condition that the avatars of the two users, each of which makes a match-making reservation, are placed in the same entrance room and the reservation is realized without using the table object of the battle room. Once the reservation is confirmed and conditions specified for the reservation (play start date and time) are satisfied, the operable avatars of these users are automatically placed in the battle room, provided that the users are logged into the service. At this point, the avatars of the two users who play the battle game are directly placed in a seated state at the chair object of table (set) object, which is controlled so as to be unselectable by other uses, so that the match-making process can be exclusively performed.

In other words, the reservation function allows the match-making process to be executed by appointing two users who will be match-making targets, thereby establishing match-making. Therefore, when avatars are placed in the battle room using the reservation function, they are placed in a seated state at chair objects corresponding to the same table set object. The match-making process starts without accepting any match-making request from each user terminal 100 on condition that both (all) avatars are present, thereby establishing match-making.

The reservation of match-making between users is set through correspondence (which is also referred to as “communication”) related to the reservation between or among multiple users whose avatars are placed in the same entrance room. For this reservation function, the match-making service according to this embodiment provides a communication function between users, which can be used when operable avatars are placed in the entrance room. By using this communication function, information exchange between user terminals 100 of these users is realized through the match-making system. As described above, since the reservation function is provided for multiple users whose avatars are placed in the same entrance room, the communication function is also provided for users whose avatars are placed in the same entrance room. Therefore, each user can use the communication function as part of the reservation function to communicate with a specific user about the reservation of match-making.

However, if arbitrary text information entered by a user is allowed to be sent through the communication function, there is a risk that inappropriate messages, such as abusive language or solicitation, may be sent to other users. Such messages can cause trouble between users or diminish users' interest in the game. Therefore, in the match-making service according to the present embodiment, the text information that can be sent and received as communication about match-making reservations is limited to predefined text information (template text information) including some editable fields. In other words, the communication function does not include the capability to send and receive newly entered text information such as freeform text entered arbitrarily by users.

The editable fields in the template text information include information about the play start time for the battle game to be played based on the match-making. The information about the play start time may be selectable from two options, for example, “now” and the play date and start time.

A user applying for match-making reservation can send a reservation request for another user with whom the user desires to play a battle game, to the server 200 by entering the play start time in the editable field of the template text information. This reservation request is sent to the user terminal 100 of the user to whom the reservation request is offered via the server 200 and presented to that user. The user who receives the reservation request can choose whether to agree to the match-making reservation associated with the request and respond thereto. That is, when a reservation application is made using the communication function, the user who receives the request can respond to the request using the communication function. Consequently, the communication function also includes transmission and reception of information (response information) related to the response to the reservation. This response information is also sent to the user terminal 100 of the user who requests the reservation as a response.

If an agreement on the match-making reservation is reached in response to the reply, the server control unit 201 manages information regarding the match-making reservation for these users. For instance, the server control unit 201 performs control to forcibly place and display the avatars of the users involved in the reservation in the battle room when the specified play start time arrives. Such placement control is performed on the condition that each user involved in the reservation is logged into the service at the play start time.

With the reservation function, each user can easily play a battle game with a desired user. Specifically, a user can make a new competition reservation with another user who visits the user's entrance room using the avatar of the user (another user). Additionally, the user can make a rematch reservation with the same opponent by moving his or her operable avatar to the entrance room related to the opponent after the battle game ends.

<Play Preparation Function> In the match-making service according the present invention, the battle game played between opponent users is a TCG (trading card game), and users participating in the battle game can progress the game by sharing information about the card game deployed on the play field in the real world and speech for declarations during turns. Therefore, each of users needs to have his or her user terminal 100 obtain the environmental information of the real space they use for the battle game. In this embodiment, the imaging unit 120 and the microphone 130 of each user terminal 100 are used to obtain information of the real space. Specifically, the imaging unit 120 of the user terminal 100 captures the information of the play field as image data, and the microphone 130 captures spoken voice related to game play as audio data.

Since the user terminals 100 are not always set up for battle games, it is necessary to perform play preparation before the battle game, so as to be able to appropriately obtain each piece of information, which is used for the battle game. However, if such play preparation is performed after transitioning to an outside service, for example, after the match-making is established, it could take time before the start of game after the establishment of the match-making, potentially prolonging duration of the overall battle game. In order to enable the other users to watch the battle game realized by the match-making between users and establishment of the match-making, the match-making service according to this embodiment is configured to ensure that the table object provided in the battle room is occupied by avatars involved in the battle game, during a period from a request for match-making until the end of game. As a result, prolongation of the time to the end may make match-making for a battle game through the same object table during the period impossible, so that the frequency of execution of battle games as a whole in the match-making service is decreased.

The match-making service according to the present invention allows the preparation of devices to obtain the real space information related to the battle game in the entrance room, so that a play preparation of users after establishment of match-making is not required. Upon condition that an operable avatar is placed in the entrance room, a user can request to use the play preparation function, and the process for the play preparation is executed in response to the request.

In this embodiment of the match-making system, the play preparation function is made available by selecting a dedicated object placed on the wall portion of the entrance room. Upon selection of this dedicated object by the user, the display 110 of the user terminal 100 switches from the service screen displaying the entrance room to a screen for play preparation (hereafter referred to as “preparation screen”). The play preparation process involves controlling operations of the imaging unit 120 and/or the microphone 130 of the user terminal 100, and the preparation screen displays information related to the operation or adjustment of these devices.

For example, the preparation screen for the imaging unit 120 includes an area displaying the captured images obtained by the imaging operation of the imaging unit 120. The preparation screen prompts the user to adjust the position of the play field used for play of the battle game, within the frame of the imaging unit 120 in preparation for a battle game. The user can adjust the position or orientation of the user terminal 100 or that of a stand for holding the imaging unit 120 while checking the image of the play field included in the captured image displayed on the preparation screen. To ensure fair play between players during the battle game, the preparation process for the imaging unit 120 may also include a step of analyzing the captured image and a step of controlling the process to end, on condition that the entire play field is included within the image.

Even when the play field is within the frame, if the field is too small, it may hinder the optimal game play. Therefore, a guide may be superimposed on the captured image. The guide indicates indexes such as the desired position and size of an image of the play field to be captured as the captured image. This guide helps the user to adjust the imaging unit 120 for optimal battle game conditions.

In addition, the preparation screen for the microphone 130 includes an area displaying an audio level of the sound signal(s) captured by the microphone 130. Since TCG progresses with players declaring a game card(s) and reading out the effects caused by the game card(s) and so on, it is preferable to have audio data shared at a volume and quality that both (all) users can clearly hear during the battle game. On the other hand, the type of microphone 130 used therefor, the audio input interface used for the user terminal 100, each user's speaking volume, and the background noise in the user's environment can affect ease of hearing or the clarity of speech voice related to the captured audio data.

Therefore, the preparation screen for the microphone 130 includes areas showing the audio level of the background noise and that of the speech audio included in the captured audio data (input audio data). The background noise and speech audio can be separated from each other by extracting unique frequency bands from the input audio data. The preparation screen may also include a graphical user interface for adjusting the audio levels to recommended settings (audio level) defined for the TCG play environment. This GUI for the adjustment may include a GUI capable of adjusting the amplification/attenuation rates by himself or herself or a GUI which automatically selects the amplification/attenuation rates so that the peak value or median of the measured audio levels satisfies conditions of a predetermined audio level.

Thus, the preparation process for the microphone 130 may be controlled so as to end, on condition that the audio level of the measured audio (either the background noise or voice audio) meets a predetermined condition(s) required for execution of the battle game. The condition(s) for the audio levels may include a condition that the audio level of the adjusted background noise is below a specified threshold, that in the case of the peak value of the audio level of the adjusted speech audio falls within a predefined range, which is determined regarding speech audio, and/or that a normal speech audio level exceeds a predefined level, which is determined regarding speech audio. Additionally, the conditions may include the audio level ratio of a speech audio level to a background noise, which exceeds a threshold.

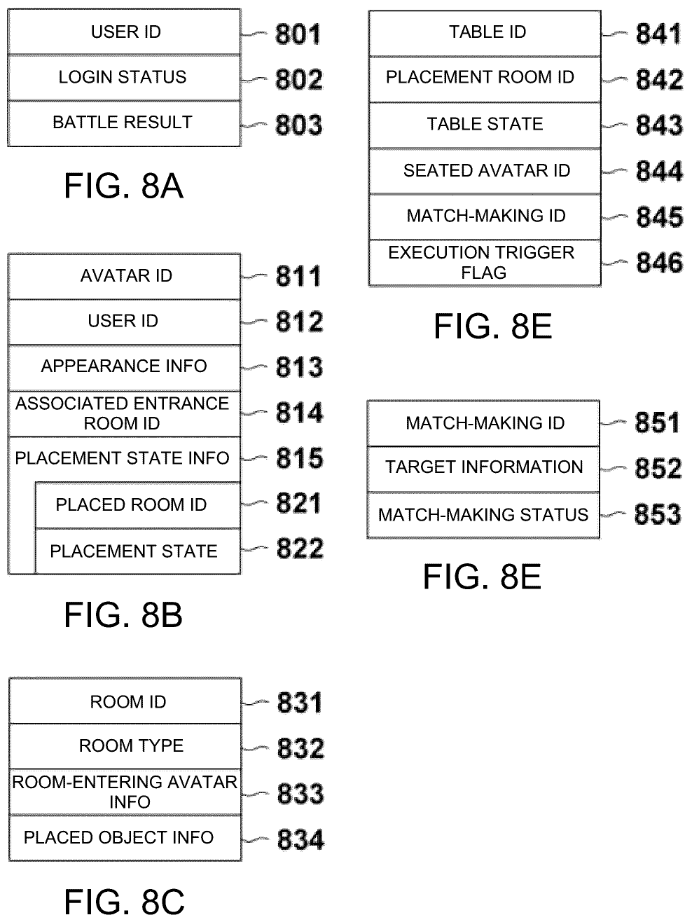

By making the preparation function available in the entrance room, the time required for preparing various devices to acquire real space information of players can be shortened in the battle game executed after the establishment of match-making in the battle room. When the process for the play preparation process in the entrance room is completed, and when information indicating that effect is associated with an operable avatar, and when it transitions to an external service, the execution of the battle game may be triggered so that the sequence related to the play preparation can be omitted. Information indicating the completion of play preparation is also transmitted to the external service. Since the time reduction effect is maximized when both players who play the battle game have completed the play preparation, control is performed so that only users who have completed the play preparation may be distinguished from others in the match-making process, thereby making the match-making available for only these users. This control can be implemented, for example, by making some table objects selectable only if such play preparation is completed or by displaying information about whether the standby user or requesting user has completed the play preparation before or when the competition request is made.

<<Information Management>> An example of a configuration of various kinds of information managed by the server 200 in relation to the match-making service according to the present embodiment, which is configured as described above, will be described with reference to FIGS. 8A to 8E.

FIG. 8A illustrates an example of a configuration of user information managed for each user. As illustrated in FIG. 8A, the user information managed for each user includes a user ID 801, login status 802, and a battle result 803. The login status 802 and the battle result 803 are managed in association with the user ID 801. The user ID 801 uniquely identifies the user. The login status 802 indicates whether the user is logged in to the service. The battle result 803 indicates the result of the battle game played by the user via the match-making service. When a service login request associated with the user ID 801 is received via the service site or when a service logout request is received, the login status 802 is updated to a corresponding value. Further, when match-making has been established and the executed battle game has ended, the battle result 803 is updated based on the received information regarding the battle result (result information). The result information may be received from the game server of the corresponding outside service or may be input by each user who has participated in the battle game.

FIG. 8B illustrates an example of a configuration of avatar information managed for each avatar. As illustrated in FIG. 8B, the avatar information managed for each avatar includes an avatar ID 811, a user ID 812, appearance information 813, an associated entrance room ID 814, and placement state information 815. The user ID 812, the appearance information 813, the associated entrance room ID 814, and the placement state information 815 are managed in association with the avatar ID 811. The avatar ID 811 uniquely identifies the avatar. The user ID 812 uniquely identifies the user associated with the avatar. The appearance information 813 indicates the appearance of the avatar. The associated entrance room ID 814 uniquely identifies the entrance room associated with the avatar. The placement state information 815 indicates the current placement state of the avatar in the virtual space. When the avatar is placed in the entrance room and an appearance change request related to the appearance customization function is received, the appearance information 813 is updated. The placement state information 815 includes a placed room ID 821 and a placement state x. The placed room ID 821 uniquely identifies the room (virtual space) in which the avatar is placed. The placement state 822 indicates the state of the avatar in the room. The state of the avatar indicated by the placement state 822 includes the match-making standby state, the match-making establishing state (or the battle game executing state), and the free state. The placement state 822 is mainly used to indicate the information regarding the avatar in the battle room. When the avatar is placed in the battle room and any of various requests related to the match-making function is received, the placement state 822 is updated to a corresponding value.

FIG. 8C illustrates an example of a configuration of virtual space information managed for each room. As illustrated in FIG. 8C, the virtual space information managed for each room includes a room ID 831, a room type 832, room-entering avatar information 833, and placed object information 834. The room type 832, the room-entering avatar information 833, and the placed object information 834 are managed in association with the room ID 831. The room ID 831 uniquely identifies the room. The room type 832 indicates whether the room is the entrance room or the battle room. The room-entering avatar information 833 is information regarding each avatar who has entered the room. The placed object information 834 is information regarding each object placed in the room. The room-entering avatar information 833, which includes information regarding each avatar which has entered the room, includes, for example, the avatar ID of the avatar and information required for drawing the room, such as the position, posture, and appearance of the avatar in the room in which the avatar is placed. When the avatar is seated in the chair object, the position information and posture information of the avatar may be values uniquely specified for the chair object. When the avatar is placed in the entrance room, the placed object information 834 may include information regarding, for example, decorations placed in the entrance room. When the user is placed in the battle room, the placed object information 834 may include table information regarding each of the table objects disposed in the room.

The virtual space information is sequentially updated according to the changes of the states of the avatars and table objects placed in a corresponding room, and is shared each time among the user terminals 100 used by the users whose avatars are placed in the same virtual space. With the virtual space information, the user terminals 100 can draw the virtual space in which the corresponding operable avatars are placed.

FIG. 8D illustrates an example of a configuration of table information managed for each table object disposed in the battle room. As illustrated in FIG. 8D, the table information managed for each table object includes a table ID 841, a placed room ID 842, a table state 843, a seated avatar ID 844, a match-making ID 845, and an execution trigger flag 846. The table state 843, the seated avatar ID 844, the match-making ID 845, and the execution trigger flag 846 are managed in association with the table ID 841 and the placed room ID 842. The table ID 841 may be an identification number assigned to each table object in the room. The placed room ID 842 uniquely identifies the room. The table state 843 indicates the use state of the table object. The seated avatar ID 844 uniquely identifies the avatar seated in the chair object associated with the table object. The match-making ID 845 uniquely identifies the match-making process being performed via the table object. The execution trigger flag 846 indicates whether or not the execution of the battle game has been triggered via the table object. A combination of the table ID 841 and the placed room ID 842 uniquely identifies each of the table objects managed in the match-making service.

The state of the table object indicated by the table state 843 includes the state in which the match-making process is being performed, the state in which the triggered battle game is being executed, and the state in which none of these are performed (the triggered battle game has ended or the match-making process has not started). When the avatar is positioned in the battle room and a match-making request related to the match-making function is received or the execution of the battle game is triggered or when result information regarding the result of the battle game is received, the table state 843 is updated to a corresponding value. When the avatar is positioned in the battle room and the match-making request based on the operation of selecting the table object is received, the seated avatar ID 844 is updated based on the identification information of the avatar. When, for example, the match-making process for the table object starts, the match-making ID 845 is issued and stored in the table information as information which is referred to for the match-making process. The match-making ID 845 is deleted in response to the completion (establishment or cancellation) of the match-making process or the end of the battle game that has been triggered and executed. The execution trigger flag 846 is, for example, a logical type of information. When the battle game is being executed on the outside service after the establishment of match-making, the execution trigger flag 846 is set to true (True). When the battle game is not being executed, the execution trigger flag 846 is set to false (False).

FIG. 8E illustrates an example of a configuration of match-making information managed for the match-making process being performed for each table object. As illustrated in FIG. 8E, the match-making information related to the match-making process includes a match-making ID 851, target information 852, and a match-making status 853. The target information 852 and the match-making status 853 are managed in association with the match-making ID 851. The match-making ID 851 uniquely identifies the match-making process. The target information 852 indicates a target to be matched in the match-making process. The match-making status 853 indicates the progress of the match-making process. The target information 852 can be, for example, the user ID of the user who is the target of the match-making, the avatar ID of the user's operable avatar, or both. The target information 852 is updated when a match-making request is received for the table object. The progress indicated by the match-making status 853 includes a match-making standby state, a state in which a request has been made, and a state in which match-making has been established. The match-making status 853 is set to the match-making standby state when the match-making process starts for the table object. After the match-making standby state, the match-making status 853 is further updated according to a match-making request related to a battle request received for that table object or according to the contents of the response to the battle request.

These pieces of information are generated, managed, and updated by the server control unit 201. Further, these pieces of information can also be stored and managed using an external storage server or the like instead of or in addition to the server storage device 202 and the server memory 203.

### <<Reservation Process>>

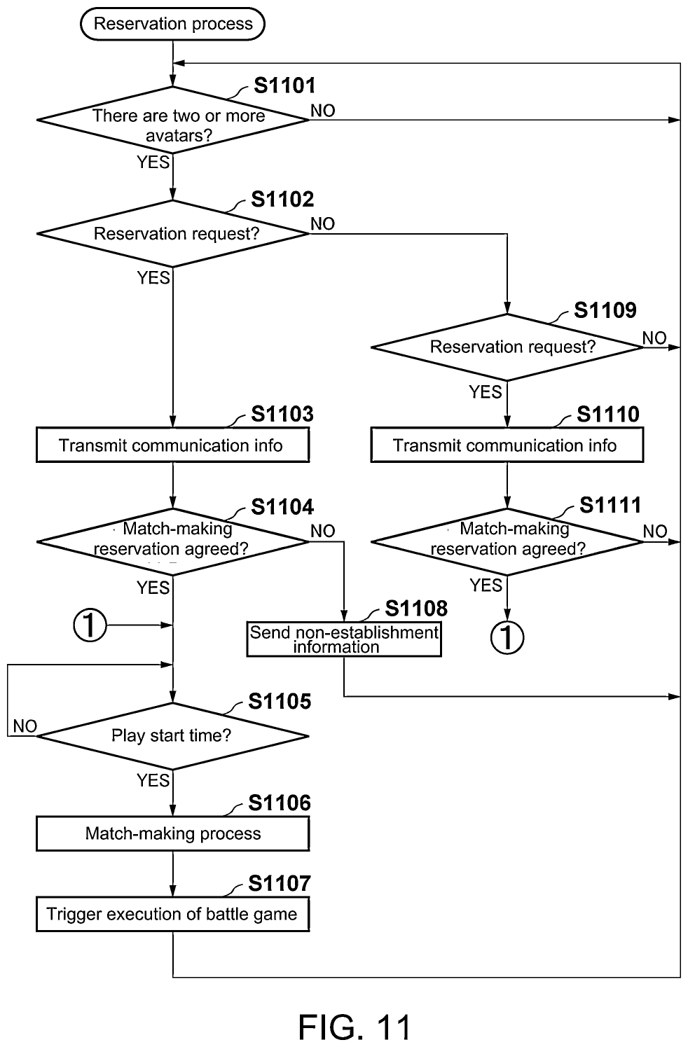

The reservation process executed by the server 200 when the operable avatar of a user is placed in one of entrance rooms will be explained below, using a flowchart shown in FIG. 11. The server control unit 201 can implement this process by reading the corresponding program stored in the server storage 202 and developing and executing it in the server memory 203. This reservation process starts when the server 200 receives a request regarding a placement of the operable avatar into the entrance room, from a user terminal 100 (such as a service login request, a transfer request to the entrance room, or a visit request to the entrance room associated with another user's avatar). In explaining this reservation process, the user terminal 100 which sends the service login request is referred to as a “target terminal,” the user using the target terminal as a “target user,” and the operable avatar associated with the target user as a “target avatar.” Alongside this reservation process, necessary information for providing the match-making service, is sent to the target terminal. The necessary information includes virtual space information, and is used for a display of the service screen on the target terminal. In this embodiment, both users involved in the match-making reservation, remain logged into the service from the time the match-making reservation is made until the play start time of the related battle game.

In S1101, the server control unit 201 determines whether multiple avatars are present in the entrance room where the target avatar is placed. This determination can be made by referring to room entering avatar information 833 in the virtual space information related to that entrance room. If the multiple avatars are present in the entrance room, the process moves to S1102, and if not, the step is repeated.

In S1102, the server control unit 201 determines whether or not it has received a reservation request related to the match-making reservation from the target terminal. In case where, for example, the entrance room where the target avatar is placed is displayed on the display 110 of the target terminal as a service screen, the reservation request is sent from the target terminal to the server 200, when another avatar in the entrance room is selected, and the input of information (communication information) to be sent to the user terminal 100 of the user of the selected avatar is completed by using the communication function. As mentioned above, the communication information includes the fixed text information and the information on the play start time. When sending the reservation request, the control unit 101 of the target terminal controls to send to the server 200 not only the communication information but also the information of a user (reservation offered user) to whom the reservation request is offered, that is, the information that uniquely identifies the avatar selected by the target user in addition to the reservation request. If the server control unit 201 determines that it has received the reservation request, the process proceeds to S1103. If the server control unit 201 determines that it has not received the reservation request, the process proceeds to S1109.

In S1103, the server control unit 201 sends the communication information to the user terminal 100 of the reservation offered user based on the received reservation request.

In S1104, the server control unit 201 determines whether or not the reservation offered user has agreed to the match-making reservation. The determination in this step can be made based on the response information received from the user terminal 100 of the reservation offered user in response to the communication information sent in S1103. If the server control unit 201 determines that the reservation offered user agreed to the match-making reservation, the process proceeds to S1105. If it determines that the reservation offered user does not agree, it proceeds to S1108.

In S1105, the server control unit 201 determines whether or not the play start time set in the agreed match-making reservation has arrived. If the server control unit 201 determines that the play start time has arrived, the process proceeds to S1106. If it determines that the time has not arrived, this step is repeated.

In S1106, the server control unit 201 forcibly transfer the target avatar and the avatar of the reservation offered user to the battle room, places these avatars in the seated state at the chairs associated with one table object, and starts the match-making process for the table object. That is, the server control unit 201 forcibly executes the match-making process in a state where no one else intervenes, to establish the match-making between the reservation offered user the target user who made the match-making reservation.

In S1107, the server control unit 201 triggers the execution of the battle game in an external service that provides the service related to the target game title for the table object where the match-making has been established. Specifically, the server control unit 201 sends a request for creating the connection destination of the battle game, to the game server of the external service, and sends the obtained connection destination information along with the transfer command to the target terminal and the user terminal 100 of the reservation offered user, thereby controlling these terminals to connect to the game server to execute the battle game. With this process, the battle game in which the target user and the reservation offered user participate is executed. After that, the server control unit 201 returns the process to S1101 upon receiving the result information related to the end of the battle game.

On the other hand, if it is determined in S1104 that the reservation offered user does not agree to the match-making reservation, the server control unit 201 sends the information indicating that the match-making reservation is not established to the target terminal in S1108 and returns the process to S1101.

Also, if it is determined in S1102 that the reservation request has not been received from the target terminal, the server control unit 201 determines in S1109 whether or not it has received a match-making reservation request, which specifies the target avatar. That is, the server control unit 201 determines whether or not it has received a reservation request directed to the target avatar from another user whose avatar is placed in the same entrance room. If the server control unit 201 determines that it has received the reservation request, the process proceeds to S1110. If the server control unit 201 determines that it has not received the request, it returns the process to S1101.

In S1110, the server control unit 201 sends the communication information received along with the reservation request for the target avatar, to the target terminal.

In S1111, the server control unit 201 determines whether or not the target user agreed to the match-making reservation. This determination can be made based on the response information received from the target terminal in response to the communication information sent in S1110. If the server control unit 201 determines that the target user agreed to the matching reservation, the process proceeds to S1105. If the server control unit 201 determines that the target user does not agree, it returns the process to S1101.

### <<Display Control Process>>

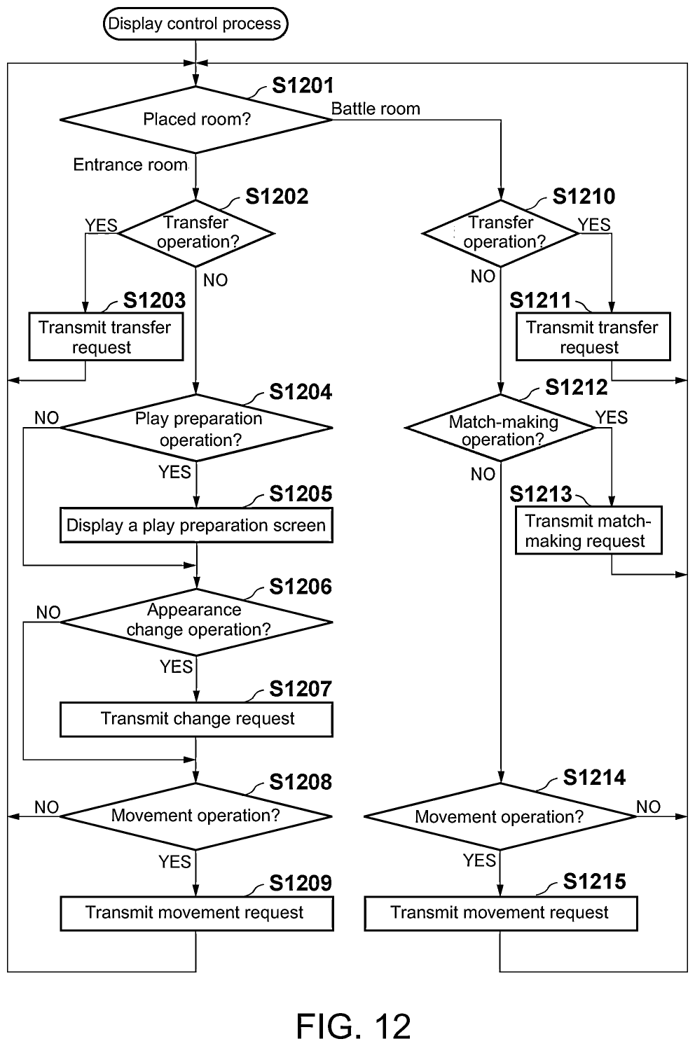

Next, in the present embodiment, the display control process executed in the user terminal 100 for the display of the virtual space at time when the match-making service is used will be specifically described referring to the flowchart of FIG. 12. The process corresponding to this flowchart can be realized by the control unit 101, which reads the corresponding processing program stored in the storage device 102, deploying it in the memory 103, and executing it. This display control process starts, for example, when the user terminal 100 accesses the service site, and the service login request and an operation input(s) related to the transition to the entrance room are accepted. In other words, this display control process starts when the user avatar corresponding to that user is placed in any one of virtual spaces in response to the request from the user, and after that, an acceptance of a transfer operation for that user avatar is allowed. Moreover, unless otherwise specified, the GPU 104 repeatedly executes the process for drawing the three-dimensional space where at least the user avatar is placed based on the virtual space information received from the server 200, and for generating the service screen during the execution of the process. In the flowchart, an explanation of the specific process related to the drawing may be omitted.

In S1201, the control unit 101 determines whether or not the user avatar is placed in the entrance room or the battle room. This determination in this step can be made by referring to the room type 832 in the virtual space information received from the server 200. If the control unit 101 determines that the user avatar is placed in the entrance room, the process proceeds to S1202. If it determines that the avatar is placed in the battle room, the process proceeds to S1210.

In S1202, the control unit 101 determines whether or not an operation input related to the transfer to another virtual space has been made. That is, the control unit 101 determines whether or not an operation input related to the transfer to the battle room or to the entrance room associated with another user's avatar has been made. If the control unit 101 determines that the operation input related to the transfer to another virtual space has been made, the process proceeds to S1203. If it determines that no such input has been made, the process proceeds to S1204.

In step S1203, the control unit 101 sends a transfer request to another virtual space, to the server 200 based on the information about the type of a room (after transferred) specified by the operation input related to the transfer to another virtual space. In response to this transfer request, the server control unit 201 updates the placement state information 815 in the avatar information, which is related to the operable avatar, the room entering avatar information 833 of the virtual space information, which is related to the entrance room where the it is currently placed, and room entering avatar information 833 of the virtual space information, which is related to be the virtual space where it is placed after the transfer. This enables the operable avatar to be placed in another virtual space. Once the process in this step is completed, the control unit 101 returns the process to S1201.

In step S1204, the control unit 101 determines whether or not an operation input related to the use of the play preparation function has been made. That is, the control unit 101 determines whether or not a selection operation has been made on a dedicated object placed on the wall of the entrance room. If the control unit 101 determines that the operation input related to the use of the play preparation function has been made, the process proceeds to S1205. If not, the process proceeds to S1206.

In step S1205, the control unit 101 controls the GPU 104 to display a preparation screen related to play preparation instead of the service screen and executes various processes related to the preparation of the device that acquires information from the real space. The various processes related to preparation may include enabling the user terminal 100 to operate and adjust the corresponding device while receiving control signals related to the play preparation operations from the server 200, or, for example, connecting to a game server related to an external service and receiving control signals related to play preparation operations.

In step S1206, the control unit 101 determines whether or not an operation input related to a change of the appearance of the operable avatar has been made. If the control unit 101 determines that an operation input related to the change of the appearance of the operable avatar has been made, the process proceeds to S1207. If not, the process proceeds to S1208.

In step S1207, based on the operation input related to the appearance change that was made, the control unit 101 sends a request to change the appearance of the operable avatar to the server 200. In response to this change request, the server control unit 201 updates the appearance information 813 of the avatar information associated with that operable avatar, and updates the room entering avatar information 833 of the virtual space information related to the entrance room where the operable avatar is currently placed, based on this avatar information. By receiving this updated virtual space information, the user terminal 100 used by the user can display the operable avatar with the changed appearance.

In step S1208, the control unit 101 determines whether or not an operation input related to moving the operable avatar has been made. If the control unit 101 determines that the operation input related to moving the operable avatar has been made, the process proceeds to S1209. If not, the process returns to S1201.

In step S1209, based on the amount of input related to the movement of the avatar, the control unit 101 sends a request for moving the operable avatar, to the server 200. In response to this movement request, the server control unit 201 executes a process to change the position and posture of the operable avatar. At this time, the server control unit 201 updates the information related to the operable avatar, which is contained in the room entering avatar information 833 of the virtual space information related to the entrance room where the operable avatar is currently placed, based on information of the amount of the operation input contained in the movement request. By receiving this updated virtual space information, the user terminal 100 used by the user can display thereon the service screen where the operable avatar is placed at a position corresponding to the movement operation. Once the process in this step is completed, the control unit 101 returns the process to S1201.

On the other hand, if it is determined in S1201 that the operable avatar is placed in the battle room, the control unit 101, in S1210, determines whether or not an operation input related to the transfer to another virtual space has been made. If the control unit 101 determines that an operation input related to the transfer to another virtual space has been made, the process proceeds to S1211. If not, the process proceeds to S1212.

In step S1211, the control unit 101 sends a request for transferring it to another virtual space, to the server 200, based on the information etc. about the type of room after the transfer, specified by the operation input related to the transfer to another virtual space. In response to this transfer request, the server control unit 201 updates the placement state information 815 of the avatar information related to the operable avatar, the room entering avatar information 833 of the virtual space information related to the battle room where it is currently placed, and, the room entering avatar information 833 of the virtual space information related to the virtual space where it will be placed after the transfer. This enables the operable avatar to be placed in another virtual space. Once the process in this step is completed, the control unit 101 returns the process to S1201.

In step S1212, the control unit 101 determines whether or not an operation input related to the use of the match-making function has been made. That is, the control unit 101 determines whether or not a selection operation has been made on a table object placed in the battle room. If the control unit 101 determines that the operation input related to the use of the match-making function has been made, it proceeds to S1213. If not, it proceeds to S1214.

In step S1213, the control unit 101 sends, to the server 200, a match-making request based on the table object to which the selection operation is performed. In response to this match-making request, the server control unit 201 executes the match-making process. Before executing this match-making process, the server control unit 201 generates or updates match-making information. The server control unit 201 also updates the placement state 822 contained in the placement state information 815 of the avatar information related to the target avatar and the table information related to the table object associated with the match-making request.

Although detailed description of the display control process in the present embodiment is omitted, the match-making process, which is executed by the server 200 based on the match-making request, may terminate under conditions such as am operation input related to the cancellation of match-making by the user, withdrawal of the battle request by the standby user, and/or establishment of match-making. Therefore, on condition that the match-making process related to the operable avatar has terminated due to the non-establishment of match-making, or that the battle game executed by the establishment of match-making has ended, if the control unit 101 receives information indicating to that effect, from the server 200, the process in this step ends and the process is returned to S1201.

In step S1214, the control unit 101 determines whether or not an operation input related to movement of the operable avatar has been made. If the control unit 101 determines that an operation input related to movement of the operable avatar has been made, the process proceeds to S1215. If not, the process returns to S1201.

In step S1215, based on the amount of input related to the movement of the avatar, the control unit 101 sends a request to move the operable avatar, to the server 200. In response to this movement request, the server control unit 201 executes a process to change the position and posture of the operable avatar. At this time, the server control unit 201 updates the information related to the operable avatar contained in the room entering avatar information 833 of the virtual space information related to the battle room where the operable avatar is placed, based on the information related to the amount of operation input contained in the movement request. By receiving this updated virtual space information, the user terminal 100 used by the user can display the service screen where the operable avatar is placed in the position corresponding to the movement operation. Once the process in this step is completed, the control unit 101 returns the process to S1201.

As described above, according to the match-making system of the present embodiment, it is possible to provide a match-making service with improved interest.

### Embodiment 2

In the match-making service described in the above embodiment, it was explained as a match-making for a battle game related to a single game title, but the present invention is not limited to this. The match-making performed by the match-making system according to the present invention may be applied to two or more types of game title.

In such a configuration, a battle room is provided for each game title so that it is easy to perform match-making with opponents for the game title that the user wishes to play. That is, a single battle room is associated with one game title, and the match-making process conducted through the battle room matches users who wish to play that game title. Which game title is associated with a battle room can be determined by referencing the room type 832 of the virtual space information related to the battle room, since the room type 832 includes information about the game title associated with that battle room.

Accordingly, the user selects a game title to play (a game title for which the user wants to be matched with an opponent) in order to transfer the user's operable avatar from the entrance room to the battle room. That is, which game content battle room, a movement request has been made for is determined based on, for example, the user's selection made while the operable avatar is positioned in the entrance room. The information regarding the selected game title is transmitted to the server 200 together with the transfer request. Based on the information, the server control unit 201 controls to place the operable avatar in the battle room associated with that game title.

Additionally, when the match-making service is configured so as to be able to perform match-making for multiple game titles, the reservation function for making reservations for match-making is configured to allow a selection of a game title to be reserved. In other words, the communication function, which can be used by selecting another avatar placed in the same entrance room when the operation avatar is placed in the entrance room, is configured to allow the user to notify the reservation offered user of the game title he or she wish to reserve for match-making. Thus, the fixed text information that can be sent and received via the communication function includes, in addition to the play start time information, an item where information indicating the game title for the match-making can be edited.

Meanwhile, in competitive or battle games such as TCGs, the physical and real items used vary depending on game titles. For example, the play field is provided for each game title and its shape differs according to the game rules, etc. Therefore, in a configuration where the match-making service allows match-making of multiple game titles, the state of the imaging unit 120 to be adjusted by the play preparation may also change. Thus, in the match-making service of the present embodiment, the play preparation function, which can be used while the operation avatar is placed in the entrance room, accepts a selection of the game title for which the user wishes to move to the battle room afterward for match-making. According to the selection of the game title, on the preparation screen for the imaging unit 120 displayed during the use of the play preparation function, a guide is displayed so as to be superimposed on the captured image corresponding to that game title. In other words, in the play preparation function according to the present embodiment, the guide indicating the position and size of the play field image to be captured as the captured image will be changed according to the game title the user wishes to match, thereby enabling appropriate play preparation.

### Modified Example 1

In the embodiments described above, each battle room primarily provides the match-making function, which matchmakes users, and the spectator function. However, embodiments of the present invention are not limited thereto. Each battle room may, for example, provide a function for selling/purchasing a relevant item related to the game content for which match-making is performed. For example, when the battle game for which the match-making function is provided is a TCG, the sale/purchase function may be provided to sell or purchase real items (game cards) that can be used in the TCG. As the sale/purchase function, a payment procedure may be performed in the match-making service. Alternatively, the sale/purchase function may be provided indirectly. For example, the user terminal 100 may be transferred to a sales page of a target product on an e-commerce (EC) website.

Further, the relevant items do not need to be real items. Instead, the relevant items may include, for example, in-game items or downloadable content.

For example, the sale/purchase function may be usable in an area (second area) different from an area (first area) in a battle room. The first area refers to an area in which the match-making function is provided in the battle room, that is, an area in which a table object is disposed. In such an embodiment, for example, the match-making function is configured to be made available to the user on condition that the operable avatar is positioned in the first area, while the sale/purchase function is configured to be made available to the user on condition that the operable avatar is positioned in the second area. That is, the server control unit 201 accepts a match-making request from the user terminal 100 and performs the match-making process on the condition that the operable avatar of the user of the user terminal 100 is positioned in the first area, while the server control unit 201 accepts a purchase request for a relevant item from the user terminal 100 and performs a sale-related process on the condition that the operable avatar of the user of the user terminal 100 is positioned in the second area.

### Modified Example 2

In the embodiments described above, a preparation screen is displayed instead of a service screen on the user terminal 100. The present invention is not limited thereto. The preparation screen may be displayed together with the service screen in a state where the preparation screen is superimposed on the service screen.

### Modified Example 3

In the embodiments, as described above, the reservation function related to reservations, is available on condition that avatars are placed in the same entrance room. The present invention is not limited thereto. For example, when multiple avatars are placed in the entrance room, since it is difficult for users to understand from which avatar user, the communication regarding the match-making reservation is sent, the reservation function may be configured so that only if avatars are close to each other (the distance therebetween becomes lower than a predetermined threshold value), the reservation function becomes available between these avatars.

### Modified Example 4

In the embodiments described above, an operation input related to the use of the match-making function is acceptable via a table object disposed in a battle room. However, the embodiments of the present invention are not limited thereto. For example, positioning an operable avatar at a specific position in the battle room may enable an operation input related to the use of the match-making function without using any object.

### Modified Example 5

In the embodiments described above, the battle game of the outside service for which match-making is provided in the match-making service has been described as a TCG. However, the embodiments of the present invention are not limited thereto. The battle game for which match-making is provided may be a battle game of another genre. Further, the game for which match-making is provided is not limited to a battle game. As long as a plurality of users can participate in the game, the game for which match-making is provided may be, for example, a game involving cooperative play etc.

Further, the game in which match-making is provided does not need to be a game which is performed using the outside service but may be a game provided as a function of the match-making service. That is, the match-making service may include a function of executing an online game in which users matched with each other by the match-making process participate. In such an embodiment, the server control unit 201 further performs a process corresponding to a game function provided by the match-making service to control the trigger of the execution of a battle game after the establishment of match-making. Accordingly, when the game provided by the game function is a TCG, the server control unit 201 controls information to be transmitted to each user terminal 100 such that the display 110 of the user terminal 100 used by one of the users participating in the TCG displays, instead of the service screen, an image captured by the imaging unit 120 of the user terminal 100 used by the other user (opponent).

### Modified Example 6

In the embodiments described above, the match-making service is provided from the server 200 to the user terminal 100 which has logged in to the service via the browser. Alternatively, the match-making service may be provided via a dedicated application installed on the user terminal 100. In this case, in order to provide the match-making service, the dedicated application may connect to an external apparatus including the server 200, transmit a processing request for part of the functions to the external apparatus, and acquire a processing result to control the display or the like related to the dedicated application. 137

### Modified Example 7

In the embodiments and modifications described above, the virtual space provided in the match-making service is a three-dimensional space in which three-dimensional models are arranged. However, the embodiments of the present invention are not limited thereto. For example, the present invention can also be applied to, for example, a two-dimensional space in which two-dimensional models are arranged.

### Summary of Embodiments

The above embodiments disclose at least the following: a program, an match-making server, and an match-making system.

(1) A program causing a computer to execute: a display control process which displays a virtual space where virtual characters associated with users are movably placed, a match-making process for performing match-making for two or more users for a battle game, a trigger process for triggering the game where the users involved in the match-making take part, on condition that the match-making is established in the match-making process, and a a communication control process for controlling transmission and reception of information related to communication between the users, wherein the virtual space includes a first virtual space and a second virtual space, the match-making process is executed for the users whose virtual characters associated therewith are placed in the first virtual space, the communication control process performs a control so as to enable the communication related to a match-making reservation between the users associated with virtual characters which are placed in a same second virtual space, and the program causes the computer to perform a control process for controlling the match-making process so as to establish the match-making about the users who make the communication related to the match-making reservation in the second virtual space.

(2) In the program according to (1), the communication control process performs a control to transmit and receive a fixed form text information as the communication related to the match-making reservation, with part of the fixed form information being partially editable.

(3) In the program according to (2), the fixed form text information which is newly entered as the communication related to the match-making reservation is controlled so as not to be transmitted or received.

(4) In the program according to (2) or (3), the communication control process performs a control to transmit and receive information corresponding to a reply to the requested match-making reservation, as the communication related to the match-making reservation, and the program causes the computer to perform a selection process for accepting a selection as to whether or not the requested match-making reservation is agreed.

(5) In the program according to (4), when an agreement is selected as the reply, the display control process places and displays the virtual characters associated with the users who make the communication related to the match-making reservation, in the first virtual space.

(6) In the program according to (5), the part of the fixed form information includes a play start time, and when the agreement is made as the reply, the display control process places and displays the virtual characters associated with the users who make the communication, in the first virtual space, on condition that the play start time specified in the communication related to the match-making reservation, arrives.

(7) In the program according to (1)-(6), the match-making reservation includes a new battle game reservation between users, and a rematch reservation therebetween.

(8) In the program according to (1)-(7), the communication control process enables the communication related to the match-making reservation between the users associated with the virtual characters, on condition that virtual characters associated with the users are adjacent to each other in the second virtual space.

(9) In the program according to any one of (1)-(8), the communication control process enables the communication related to the match-making reservation between the users associated with the virtual characters, on condition that a distance between the virtual characters in the second virtual space is less than a threshold value.

(10) In the program according to any one of (1)-(9), the second virtual space is associated with the respective virtual characters, and the program causes the computer to perform the process for accepting a transfer command to the second virtual space, which is associated with another virtual character.

(11) In the program according to (10), the display control process displays predetermined identification information of another virtual character which has a predetermined relationship with the virtual character associated with the user, among virtual characters placed in the second virtual space, near the another virtual character.

(12) In the program according to (10) or (11), the display control process changes and displays an interior decoration of the second virtual space according to a status of the virtual character associated with the second virtual space.

(13) In the program according to (12), the display control process changes and displays the interior decoration of the second virtual space according to at least one of the number of game plays, which are executed through the match-making of the virtual characters associated with the second virtual space, and the number of wins thereof.

(14) In the program according to (12) or (13), the interior decoration of the second virtual space includes a decoration related to a play result of the game executed through the match-making via the virtual characters associated with the second virtual space.

(15) A match-making server comprises a display control unit which displays a virtual space where virtual characters associated with users are movably placed, a match-making unit which performs match-making of users for a battle game, a trigger unit which triggers execution of the battle game where the users involved in the match-making take part, on condition that the match-making is established by the match-making unit, and a communication control unit for controlling transmission and reception of information related to communication between the users, the virtual space includes a first virtual space and a second virtual space, the match-making unit performs the match-making for the users whose virtual characters associated therewith are placed in the first virtual space, the communication control unit performs a control so as to enable the communication related to a match-making reservation between the users whose virtual characters associated therewith are placed in a same second virtual space, and a control unit for controlling the match-making unit so as to establish the match-making about the users who make communication related to the match-making reservation in the second virtual room.

(16) A match-making system comprises a display control unit which displays, on a display unit of an information process apparatus, a virtual space where virtual characters associated with users are movably placed, a match-making unit which performs match-making of the users for a battle game, a trigger unit which triggers the battle game where the users involved in the match-making take part, on condition that the match-making is established by the match-making unit, and a communication control unit which controls transmission and reception of information related to communication between the users, the virtual space includes a first virtual space and a second virtual space, the match-making unit performs the match-making for the users whose virtual characters associated therewith are placed in the first virtual space, the communication control unit performs a control so as to enable the communication related to a match-making reservation between the users whose virtual characters associated therewith are placed in a same second virtual space, and a control unit, which controls the match-making unit so as to establish the match-making about the users who make the communication related to the match-making reservation in the second virtual room.

### Another Embodiment

The present invention is not limited to the above-described embodiments, various modifications and/or changes thereof may be made within the subject matter of the present invention.

1. A program causing a computer to execute:
a display control process which displays a virtual space where virtual characters associated with users are movably placed;
a match-making process which performs match-making for the users who play a game;
a trigger process which triggers execution of the battle game where the users involved in the match-making take part, on condition that the match-making is established in the match-making process, and
a communication control process which controls transmission and reception of information related to communication between the users,
wherein the virtual space includes a first virtual space and a second virtual space,
the match-making process is executed for the users whose virtual characters associated therewith are placed in the first virtual space,
the communication control process performs a control so as to enable communication related to a match-making reservation between the users associated with virtual characters which are placed in a same second virtual space, and
the program causes the computer to perform a control process for controlling the match-making process so as to establish the match-making about the users who make the communication related to the match-making reservation in the second virtual space.

2. The program according to claim 1, wherein the communication control process performs a control to transmit and receive fixed form text information as the communication related to the match-making reservation, with part of the fixed form sentence being partially editable.

3. The program according to claim 2, wherein the fixed form text information which is newly entered as the communication related to the match-making reservation is controlled so as not to be transmitted or received.

4. The program according to claim 2, wherein the communication control process performs a control to transmit and receive information corresponding to a reply to the requested match-making reservation, as the communication related to the match-making reservation, and the program causes the computer to perform a selection process for accepting a selection as to whether or not the requested match-making reservation is agreed.

5. The program according to claim 4, wherein when an agreement is selected as the reply, the display control process places and displays the virtual characters associated with the users who make the communication related to the match-making reservation in the first virtual space.

6. The program according to claim 5, wherein the part of the fixed form information includes a play start time, and when the agreement is made as a reply, the display control process places and displays, in the first virtual space, the virtual character associated with the users who make the communication, on condition that the play start time specified in the communication related to the match-making reservation, arrives.

7. The program according to claim 1, wherein the match-making reservation includes a new game reservation between users, and a rematch reservation therebetween.

8. The program according to claim 1, wherein the communication control process enables the communication related to the match-making reservation between the users associated with the virtual characters, on condition that virtual characters associated with the users are close to each other in the second virtual space.

9. The program according to claim 1, wherein the communication control process enables the communication related the match-making reservation between the users associated with the virtual characters, on condition that a distance between the virtual characters in the second virtual space is less than a threshold value.

10. The program according to claim 1, wherein the second virtual space is respectively associated with the virtual characters, and the program causes the computer to perform a process for accepting a transfer command to the second virtual space, which is associated with another virtual character.

11. The program according to claim 10, wherein the display control process displays predetermined identification information of the another virtual character which has a predetermined relationship with the virtual character associated with the user, among virtual characters placed in the second virtual space, near the another virtual character.

12. The program according to claim 10, wherein the display control process changes and displays an interior decoration of the second virtual space according to a status of the virtual character associated with the second virtual space.

13. The program according to claim 12, wherein the display control process changes and displays the interior decoration of the second virtual space according to at least one of the number of game plays, which is executed through the match-making by using the virtual characters associated with the second virtual space, and the number of wins thereof.

14. The program according to claim 12, wherein the interior decoration of the second virtual space includes a decoration related to a play result of the game executed through the match-making by using the virtual characters associated with the second virtual space.

15. A match-making server comprising:
a display control unit which displays a virtual space where virtual characters associated with users are movably placed;
a match-making unit which performs match-making of the users who play a game;
a trigger unit which triggers execution of the game where the users involved in the match-making take part, on condition that the match-making is established by the match-making unit, and
a communication control unit which controls transmission and reception of information related to communication between the users,
wherein the virtual space includes a first virtual space and a second virtual space,
the match-making unit performs the match-making for the users whose virtual characters associated therewith are placed in the first virtual space,
the communication control unit performs a control so as to enable communication related to a match-making reservation between the users whose virtual characters associated therewith are placed in the same second virtual space; and
a control unit, which controls the match-making unit so as to establish the match-making about the users who make the communication related to the match-making reservation in the second virtual room.

16. A match-making system comprising:
a display control unit which displays, on a display unit of an information process apparatus, a virtual space where virtual characters associated with users are movably placed;
a match-making unit which performs match-making of the users who play a game;
a trigger unit which triggers execution of the game where the users involved in the match-making take part, on condition that the match-making is established by the match-making unit, and
a communication control unit which controls transmission and reception of information related to communication between the users,
wherein the virtual space includes a first virtual space and a second virtual space,
the match-making unit performs the match-making for the users whose virtual characters associated therewith are placed in the first virtual space,
the communication control unit performs a control so as to enable communication related to a match-making reservation between the users whose virtual characters associated therewith are placed in a same second virtual space; and
a control unit, which controls the match-making unit so as to establish the match-making about the users who make the communication related to the match-making reservation in the second virtual room.
